(19) United States
(12) Patent Application Publication
(10) Pub. No.: US 2007/0239512 A1
(43) Pub. Date: Oct. 11, 2007

(54) CONTRACTOR MANAGEMENT METHOD AND SYSTEM

(76) Inventor: John Philip Scott, Wellington (NZ)

Correspondence Address: BALDWINS, LEVEL 14, BALDWIN CENTER, 342 LAMBTON QUAY, WELLINGTON, NZ

(21) Appl. No.: 11/693,676

(22) Filed: Mar. 29, 2007

(30) Foreign Application Priority Data
Mar. 31, 2006 (NZ) NZ PROV 546308
Aug. 22, 2006 (NZ) NZ COMP 546308

(51) Int. Cl. G06F 9/46

(52) U.S. Cl. 705/9

(57) ABSTRACT

A computer-implemented method for recruiting a contractor for a position in one of a plurality of organisations is disclosed. The method includes the steps of (a) determining the availability of a contractor using a database of contractors, and (b) reserving the contractor for the position where at least some of the contractors in the database are contracted for a period of time to an organisation, and the database includes information related to the end date for each period of time.

### FIELD OF INVENTION

The present invention relates to a contractor management method and system. More particularly, but not exclusively, the present invention relates to a contractor management method and system for recruiting information technology contractors.

### BACKGROUND TO THE INVENTION

Any discussion of publications cited throughout the specification should in no way be considered as an admission that such publications constitute prior art.

Currently companies that provide the service of locating contractors for clients and locating jobs for contractors do so in much the same way as they find employees for clients and permanent jobs for people. This has resulted in a business process for contracting which is similar to recruitment but faster.

Unfortunately this process is less than ideal as contractors are not employees and change their jobs at frequent intervals. Recruiters are obliged to keep records of all the contractors they know so that they con contact likely candidates when a client requires someone to fill a contract. This results in every recruiter keeping records of as many contractors as they can and when they discover a contract is available contacting all their contractors to see who is available to fill the contract.

This can lead to conflicts as recruiters often end up in a dispute over who has the rights to a particular contractor. The contractor may then attempt to play the recruiters off against each other to bargain for more money. Frequently the client becomes embroiled in this, otherwise unnecessary, negotiation. As a consequence of this clients attempt to reduce the number of recruiters that they will deal with and set up systems to release jobs and contracts to the agreed recruiters at the same time to give the recruiters equal opportunity in the race to find suitable contractors. The conflict, however, still exists.

The recruiter who has successfully reached agreement with a few suitable contractors can present each contractor's curriculum vitae to the client for assessment. If the contractors are suitable the recruiter is in a strong position and can raise their fee. Recruitment firms generally charge for NZ$10 to NZ$15 (and as high as NZ$20) added to the hourly rate quoted to the client. Some larger clients are able to negotiate for lower rates with some of the recruiters, but effectively the recruiter is able to hold most clients to ransom.

Another disadvantage with the present methods of recruiting contractors is that the recruiters must operate with their contractors in secret because their advantage is their set of contractors and the recruiter wants to retain them exclusively if possible. Naturally though, the contractors contact as many recruiters as they can to increase their chance of obtaining a contract.

It is an object of the present invention to overcome the above disadvantages by providing a more effective contractor management method and system, or to at least provide the public with a useful choice.

### SUMMARY OF THE INVENTION

According to a first aspect of the invention there is provided a computer-implemented method for recruiting a contractor for a position in one of a plurality of organisations, including the steps of:
i) determining the availability of a contractor using a database of contractors; and
ii) reserving the contractor for the position;
   wherein at least some of the contractors in the database are contracted for a period of time to an organisation and the database includes information related to the end date for each period of time.

It is preferred that the organisation recruiting the contractor directly determines the availability in step (i). Furthermore, the organisation preferably determines the availability using a graphical user interface. The graphical user interface may be executing on a browser. The database may be stored on a server and the browser may be connected to the server over a network. Preferably, the network is the internet.

It is preferred that the organisation recruiting the contractor directly reserves the contractor in step (ii). Preferably, the organisation reserves the contractor using a graphical user interface. The graphical user interface may be executing on a browser. The database may be stored on a server and the browser may be connected to the server over a network. Preferably, the network is the internet.

Preferably, the database includes a list of skills for each contractor. The database may include a rating for each of the skills. The rating may be based on the performance of the contractor under previous contracts.

The database may include a self-rating for each contractor. At least some of the self-ratings may have been validated by an independent party.

The database may include references for each contractor.

The database may include one or more notes for one or more contractor by one or more organisations.

It is preferred that the contractor is an Information Technology contractor.

Preferably, the step of determining the availability of a contractor is based at least in part on the end date for each period of time.

The method may involve displaying a list of available contractors. This list may comprise the end date for each contractor contained therein. The displaying may comprise directly displaying the list to the organisation recruiting the contractor.

According to a second aspect of the invention there is provided a system for recruiting a contractor for a position in one of a plurality of organisations, including:
(i) a memory arranged for storing a database, the database arranged for storing information about contractors; and
(ii) a processor arranged for determining the availability of a contractor using the database and reserving the contractor for the position;
   wherein at least some of the contractors in the database are contracted for a period of time to an organisation and the database includes information related to the end date for each period of time.

Preferably, the memory and the processor are arranged to enable the organisation recruiting the contractor to directly determine the availability.

The processor may be arranged to determine the availability based at least in part on the end date for each period of time.

The system may comprise a display for displaying a list of available contractors. This list may comprise the end date for each contractor contained therein.

The display may be arranged to directly display the list to the organisation recruiting the contractor.

According to a third aspect of the invention there is provided software for implementing the method of system of the invention.

According to a fourth aspect of the invention there is provided storage media for storing the software of the present invention.

Unless the context clearly requires otherwise, throughout the description and the claims, the words ‘comprise’, ‘comprising’, and the like are to be construed in an inclusive sense as opposed to an exclusive or exhaustive sense; that is to day, in the sense of “including, but not limited to”.

### BRIEF DESCRIPTION OF THE DRAWINGS

Embodiments of the invention will now be described, by way of example only, with reference to the accompanying drawings in which:

FIG. 1: shows a flowchart illustrating a method of the invention by which contractors can register their information.

FIGS. 2 to 10: shows screenshots illustrating a software implementation of the invention

FIG. 11: shows a flowchart illustrating a method of the invention

FIGS. 12 to 17: shows screenshots illustrating a software implementation of the invention

FIG. 18: shows a block diagram illustrating how the invention may be deployed on hardware

### DETAILED DESCRIPTION OF PREFERRED EMBODIMENTS

The present invention relates to a contractor management method and system.

The present invention will be described in relation to IT contractors. However, it will be appreciated that, with minor modifications, the system may be adapted for use with the recruitment of other contract/non-permanent staff.

The contractor management system is described operating under the control of a recruitment consultancy. However, it will be appreciated that the system can operate under other control arrangements.

Furthermore, the system will be described as operating over the internet in an ASP-style model accessible by a user through a standard internet browser.

The system assists IT contractors to register their information including their availability for work within a database.

The system also assists IT project managers or HR personnel from an employer to search for the most appropriate contractors to fill open contracts.

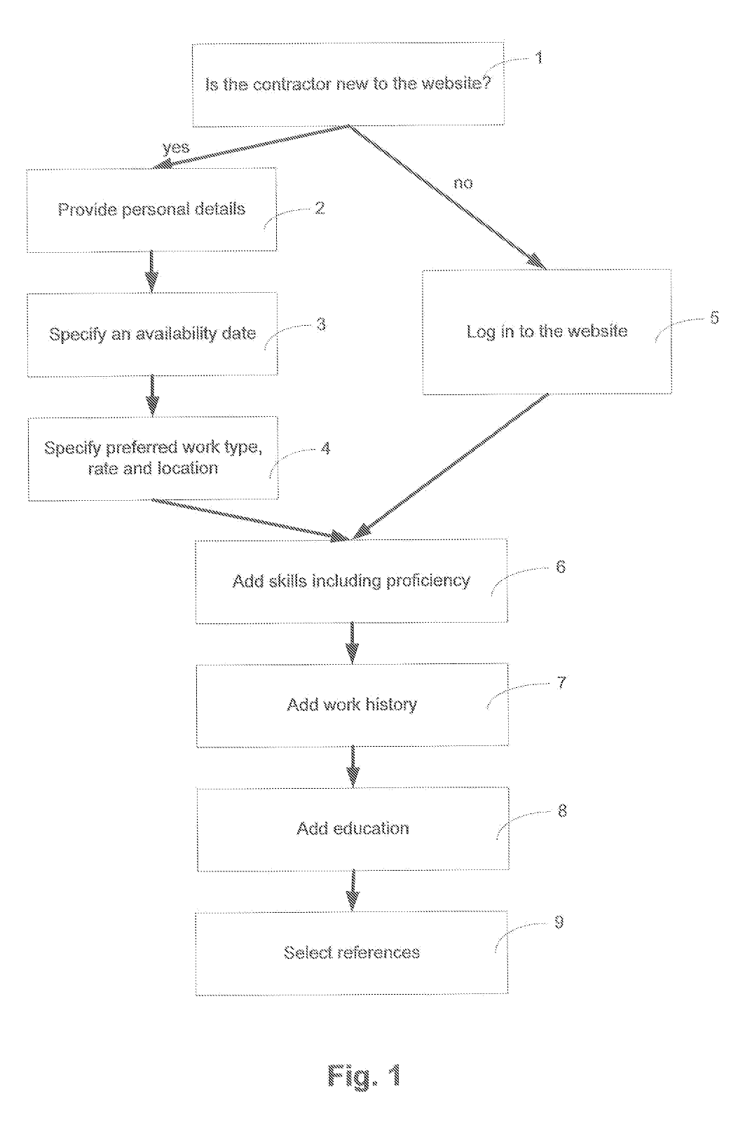

Referring to FIG. 1, how the system assists contractors to register their information for potential employers will now be described.

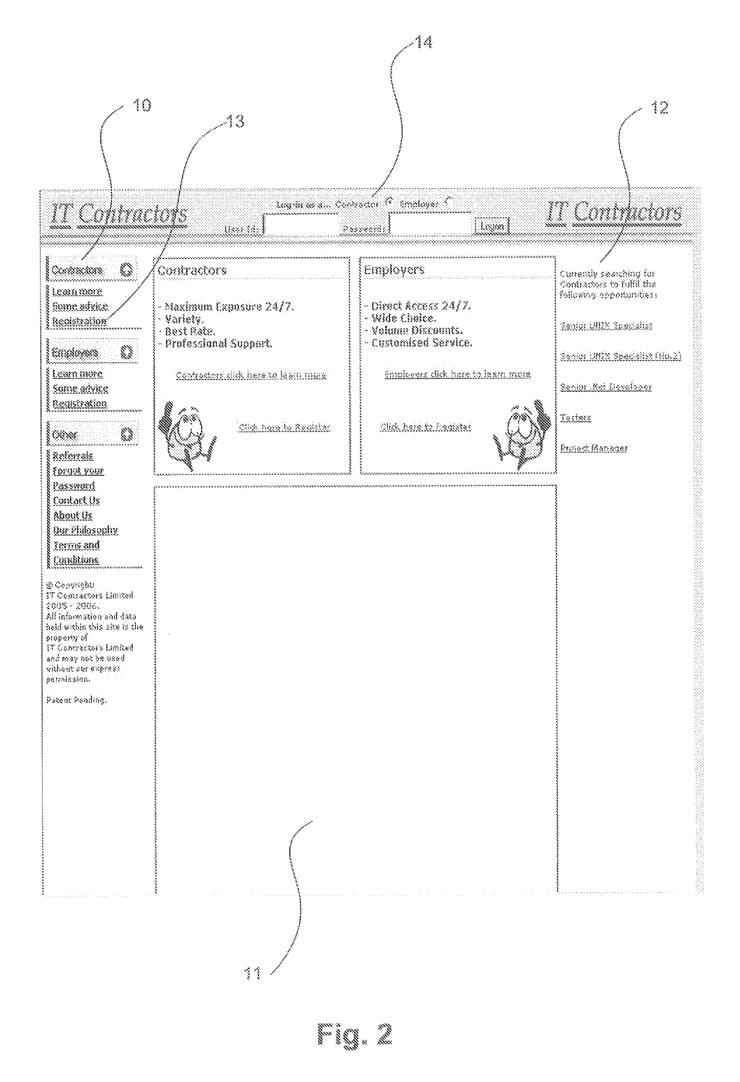

The contractor opens a web page for the internet site on which the system is hosted. A web page is shown to the contractor such as shown in FIG. 2. The web page contains a series of links to additional web pages 10 and space for advertising 11. The web page initially shown to a contractor and many of the subsequent web pages shown to the contractor may contain a list 12 of jobs currently available within the system. A contractor may click the link of any job they are interested in to find out more information about the job.

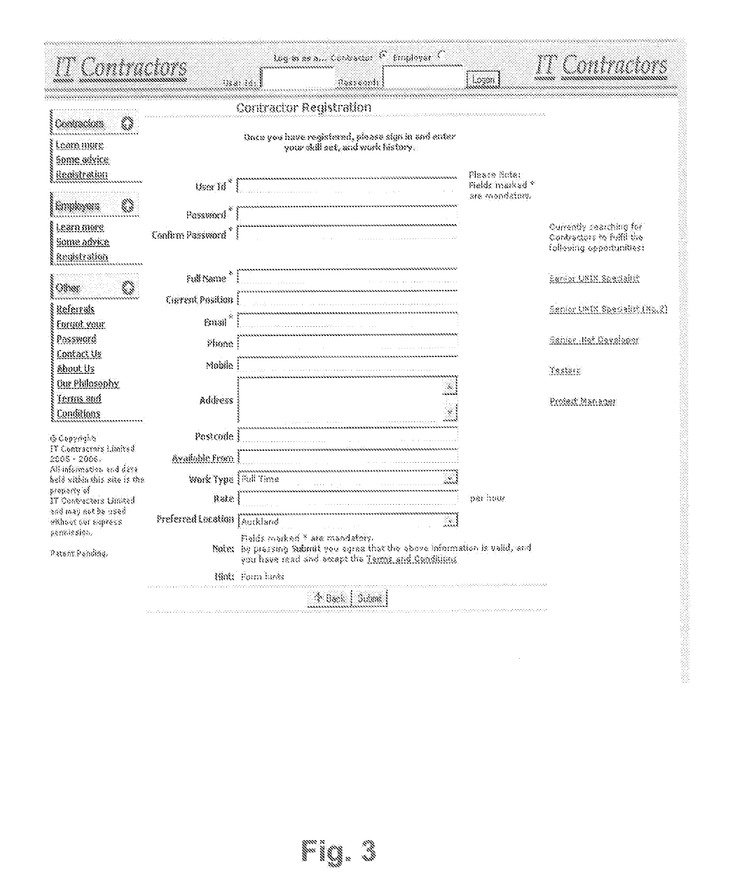

In step 1 shown in FIG. 1, the contractor determines whether they are new to the website. If a new contractor clicks on a job on the right of the web page, they will be invited to register and shown the web page such as shown in FIG. 3. If the contractor is new to the system the contractor can choose to join the system by clicking a link 13.

The new contractor will be shown a web page such as shown in FIG. 3. In step 2 (FIG. 1), the contractor enters their personal details such as a userID, password, full name and contact details.

The contractor also specifies from when they are available to work in step 3 (FIG. 1). For example, if a contractor is presently engaged in a project they will provide the end date of the contract as the start of their availability.

The contractor also enters further details such as their preferred work type, rate and location in step 4. Furthermore, the contractor can nominate companies they do not wish to work for and can upload their CV.

At step 1, if it is determined that the contractor is known to the system, they can login directly in step 5 by providing their username and password 14 on the web page shown in FIG. 2.

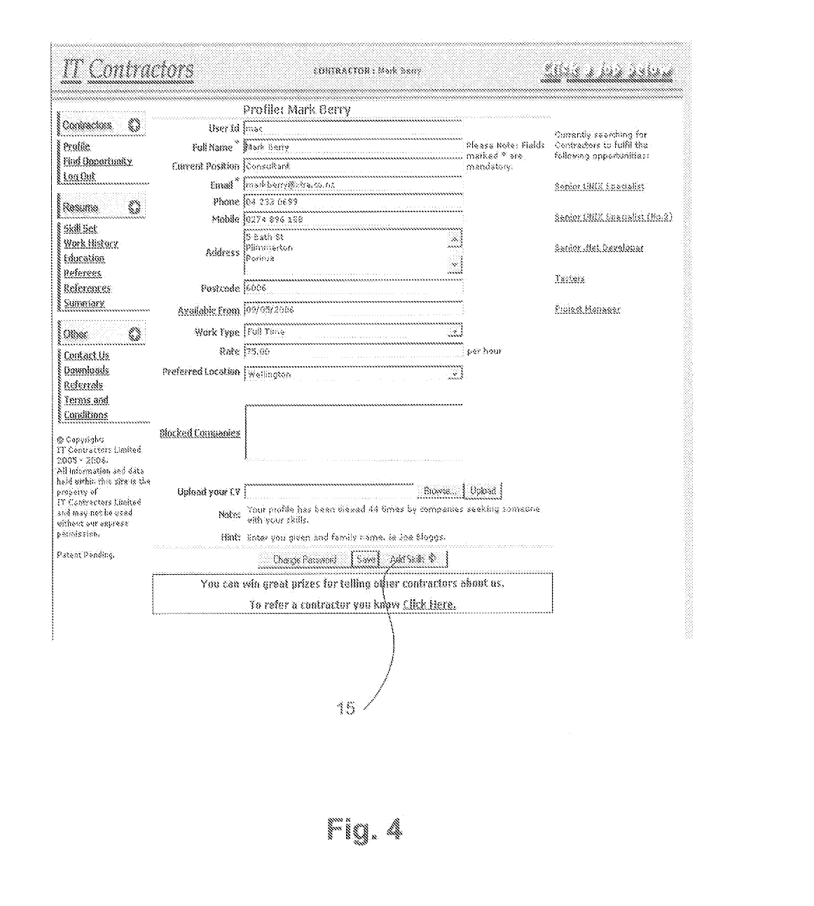

Once a new contractor has registered or a known contractor has logged in, a web page displaying a profile for the contractor is shown, such as that shown in FIG. 4.

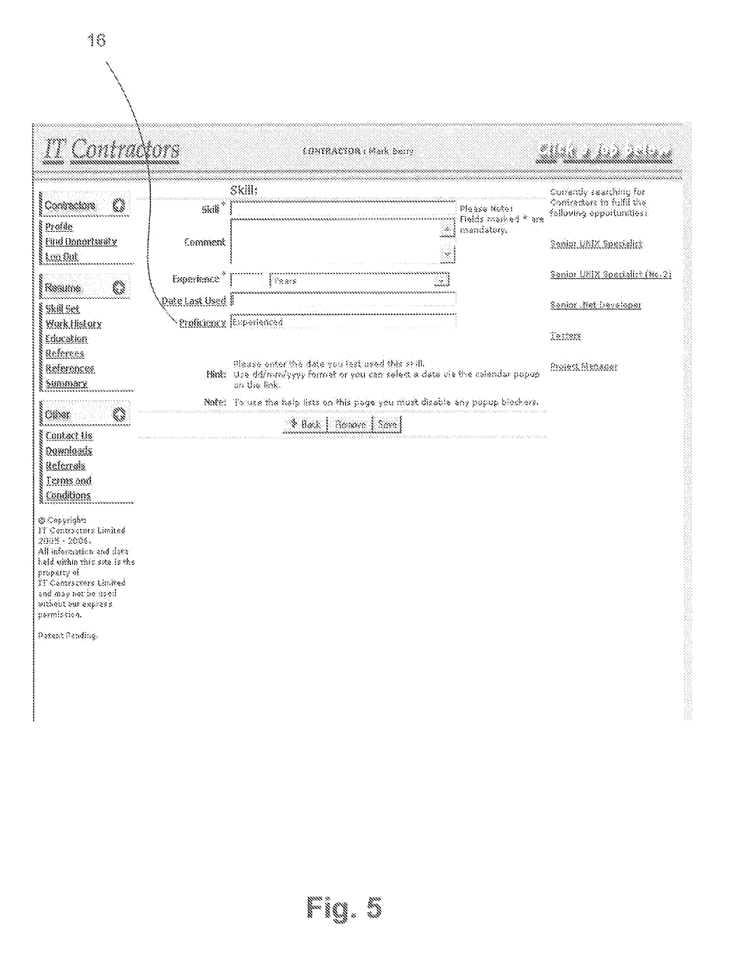

The contractor can add skills to their profile in step 6 (FIG. 1) by clicking a button 15. A “skill” provides an explanation of the contractor's capabilities. If the contractor selects the option to add skills to their profile a screen such as shown in FIG. 5 is displayed.

The contractor enters appropriate skills such as Business Analyst, Java Programmer, C++ Programmer, Help Desk, Test Analyst, Rational Rose Experience, or Project Management in FIG. 5. The contractor then selects a proficiency level 16 for that skill. The proficiency levels are standardised and are selected from the following list:

| Competency Name | Description |
|---|---|
| Guru | The Guru has had full education and training in this skill and has been |
| | actively working in commercial enterprises and/or public organizations |
| | for many years utilizing this expertise. They will be recognised as an |
| | industry expert by their colleagues and will have been asked to speak at |
| | seminars on this topic here in New Zealand and perhaps overseas. The |
| | Guru's knowledge is complete and they can answer any question fully |
| | and confidently. Previous employers all speak very highly of their work. |
| Advanced | The Advanced contrctor has 10 or more years of experience in the |
| | information Technology world and has worked in a variety of public |
| | organisations and/or in commercial enterprises. They been fully |
| | trained in this skill and have used this skill in real life projects for many |
| | years. The Advanced contractor will have extensive knowledge and |
| | experience in this skill and a full appreciation of related skill areas so |
| | that they will always fit into any new environment with no trouble at |
| | all. They are the ones people come to for advice in this skill area. |
| | Their peers would regard them as the guru. Advice from the Advanced |
| | contractor is always practical common sense and tailored to the |
| | knowledge level of the enquirer. Previous employers all speak very |
| | highly of their work. |
| Experienced | The Experienced contractor has 10 or more years of experience in the |
| | Information Technology world and has worked in a variety of public |
| | organisations and/or in commercial enterprises. They are very |
| | experienced in this and related skill areas and have wide experience in a |
| | number of environments. The Experienced contractor is regarded as |
| | very competent by their peers and previous employers speak very well |
| | of their work. The Experienced contractor will always fit into any new |
| | environment with no trouble at all. |
| Competent | The Computer contractor has been trained in this skill but direct |
| | experience is somewhat limited. However, because of very skills |
| | in closely related areas they are able to work in this area competently. |
| | The Competent contractor has been working in the Information |
| | Technology world for less than 10 years. Previous employers speak |
| | very well of their work. |
| Practical Experience | The Practical Experience contractor has not had much formal training |
| | in this skill but has strong experience in related areas and this has |
| | enabled them to learn this skill and to operate competently in real life |
| | The Practical Experience contractor will have good practical |
| | experience in this skill and their work is well received. Previous |
| | employers speak very well of their work. |
| Average | The Average contractor thinks that their capabilities in this skill are |
| | about average for the people that work in this area. They are capable of |
| | completing tasks given with minimum detailed instruction and work |
| | without supervision. Previous employers think well of their work. |
| Trained, No | The Trained, No Experience contractor has formed training in this skill |
| Experience | set but has little or no direct practical real life experience. It is not |
| | likely they would be much help to an employer as a contractor at this |
| Novice | level. The Novice contractor has some idea of this skill but has not |
| | studied it or applied it in the real world. The skill is just mentioned |
| | for the sake of completeness. |

It will be appreciated that the proficiency levels may be standardised in any other way.

The contractor can access the description of the proficiency 16 to assist them to choose the proficiency level that is appropriate to their situation.

Contractors can list as many skills as they wish and choose the appropriate proficiency level for each one.

The consultancy validates this “self-rating” by having an experienced IT consultant undertake an interview with the contractor.

The rating can be adjusted at any time to reflect additional skills and experience. In an alternative embodiment an additional rating can be supplied by the consultancy after an interview with the contractor had taken place. In yet a further embodiment the consultancy can reassess the contractor after each contract.

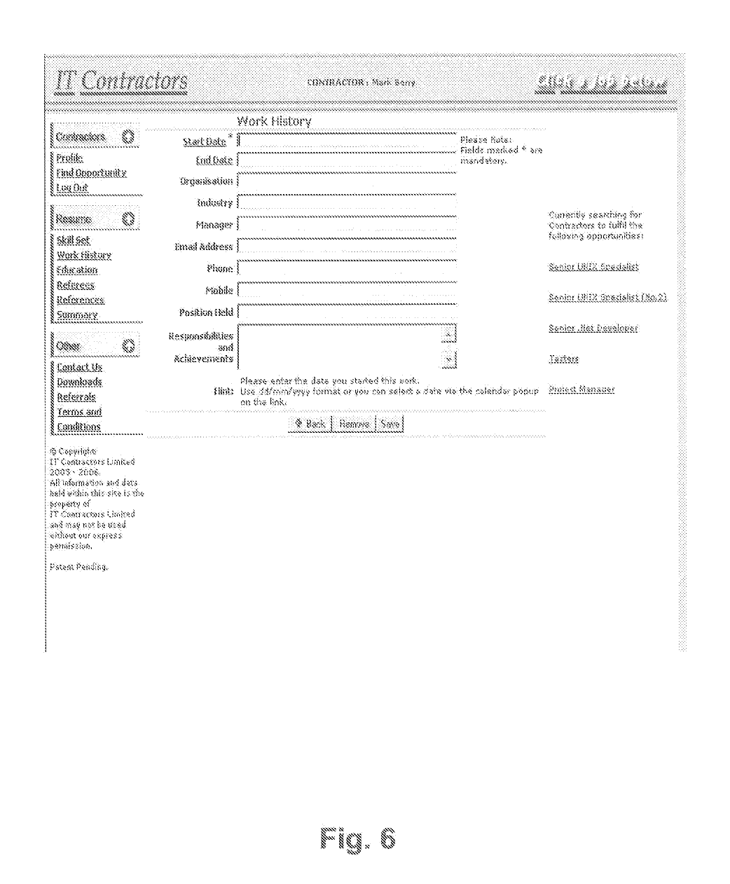

The contractor can add work history in step 7 (FIG. 1) to their profile as shown in FIG. 6. The work history provided by the contractor can include the name of the company for whom the contractor worked, the period of the contract, and the role that was performed.

In addition, the work history may be automatically updated when a contractor obtains and completes a contract obtained through the system.

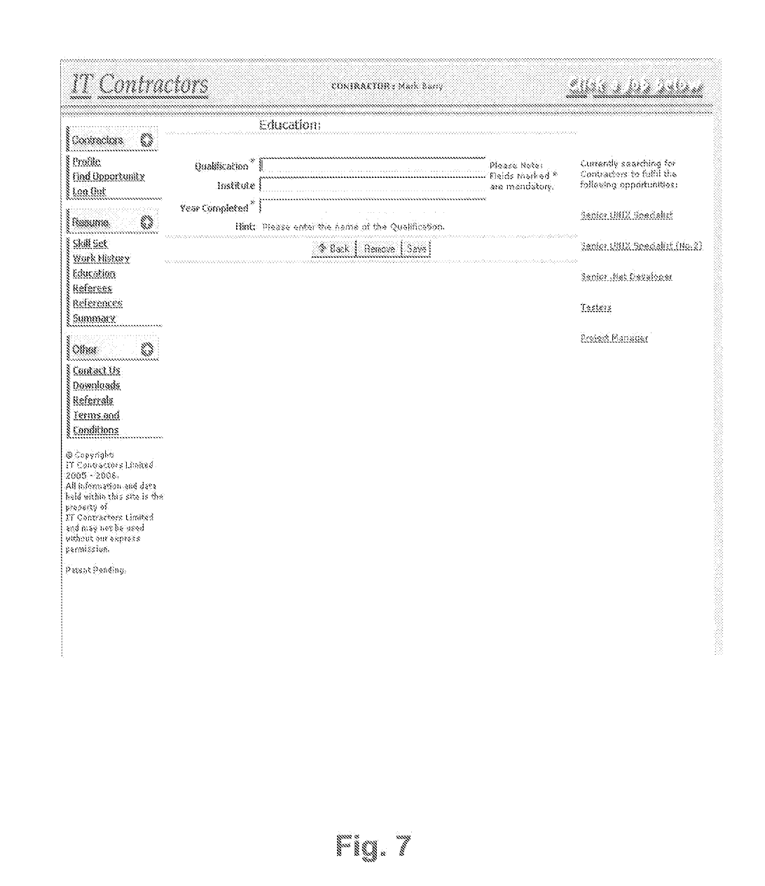

The contractor can add their education details in step 8 (FIG. 1) as shown in FIG. 7.

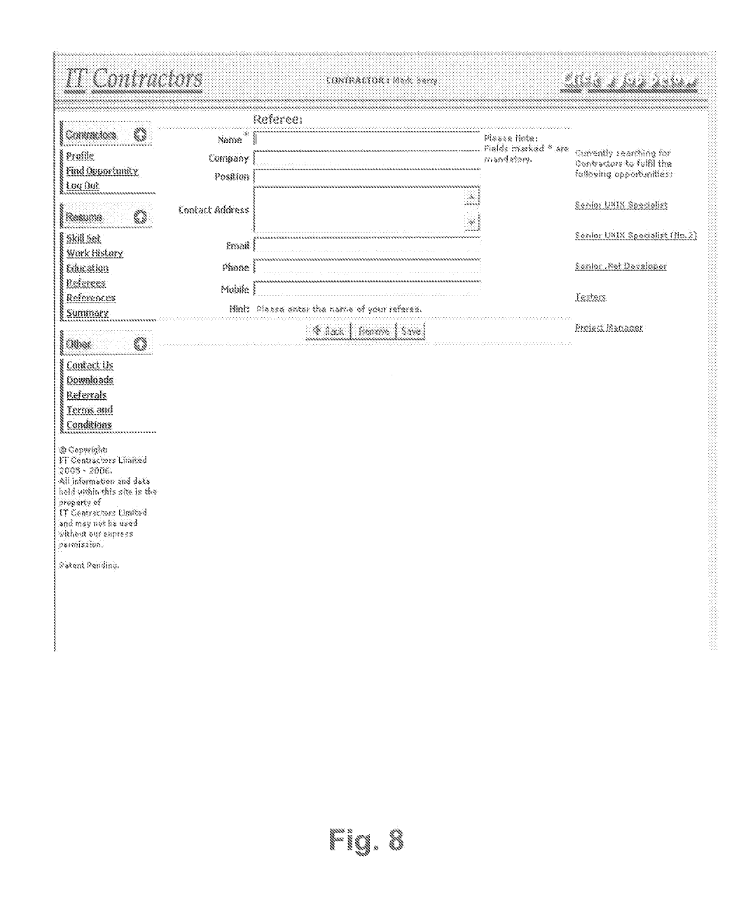

In step 9, and as shown in FIG. 8, the contractor can add references provided for them through the system to their profile.

If a registered contractor clicks on a job on the right of any of the preceding web pages, they will be shown more information about the selected job and may send an email to the employer.

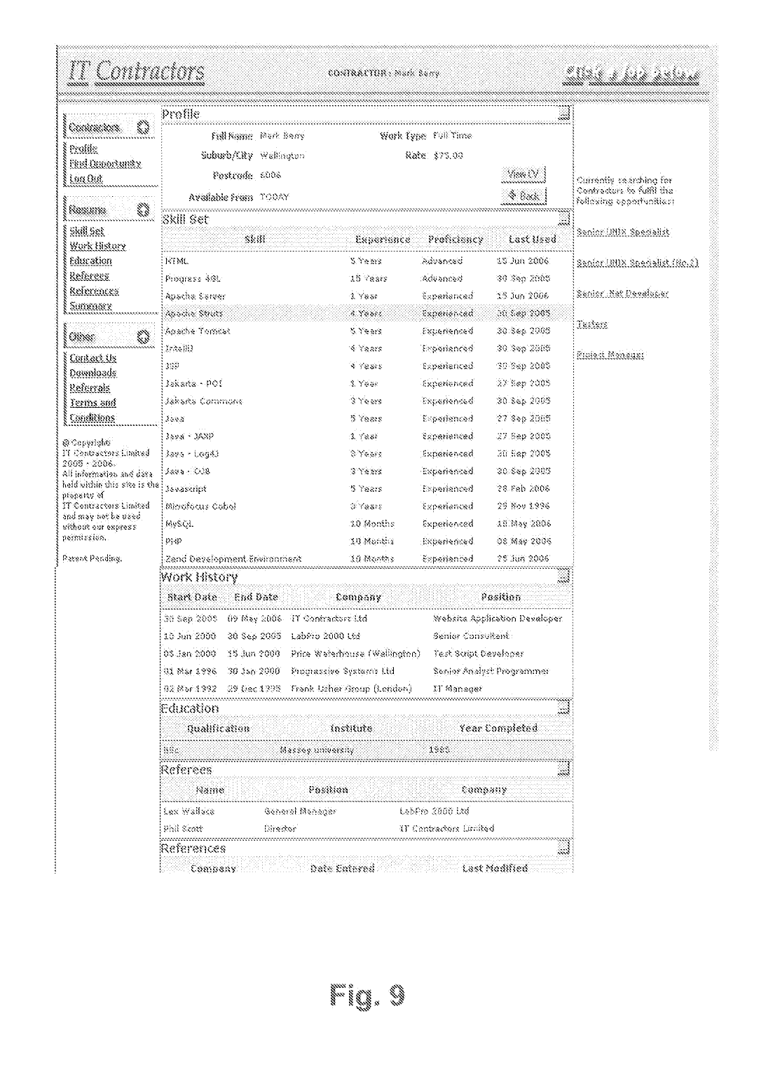

A registered contractor may view a summary of their profile as shown in FIG. 9.

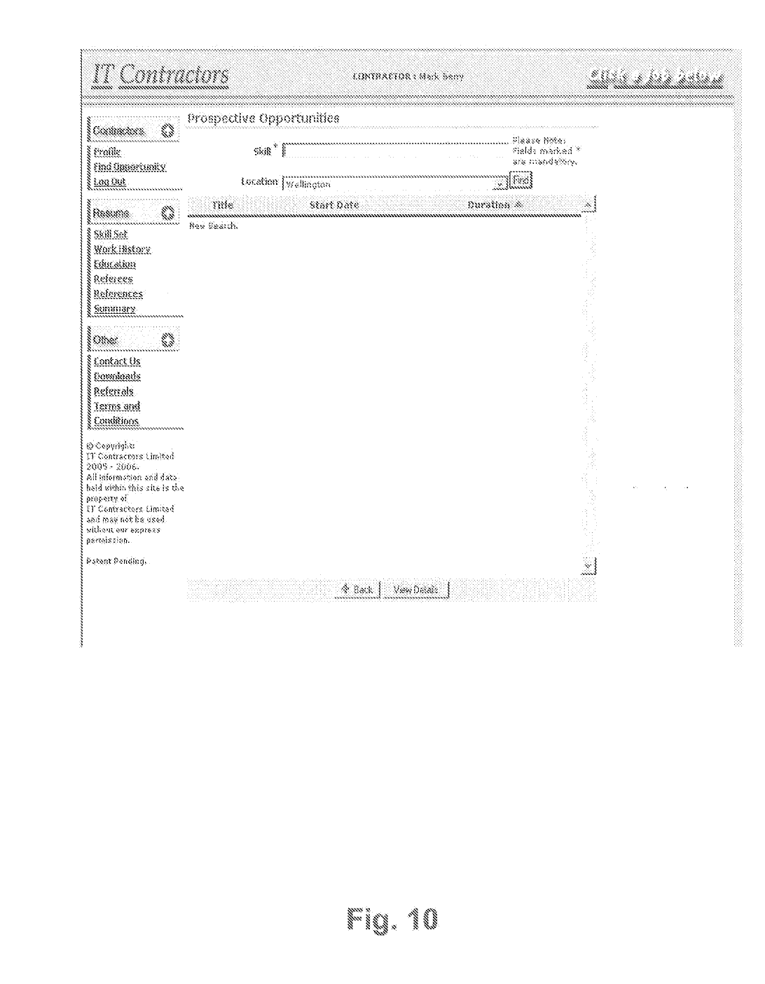

A registered contractor may search for contract opportunities appropriate to their skills. An example of a search form is shown in FIG. 10. The contractor may enter a skill and their preferred work location and view contracts matching these parameters. The contractor can view selected details of matching contracts and can send an email to the employer requesting further information.

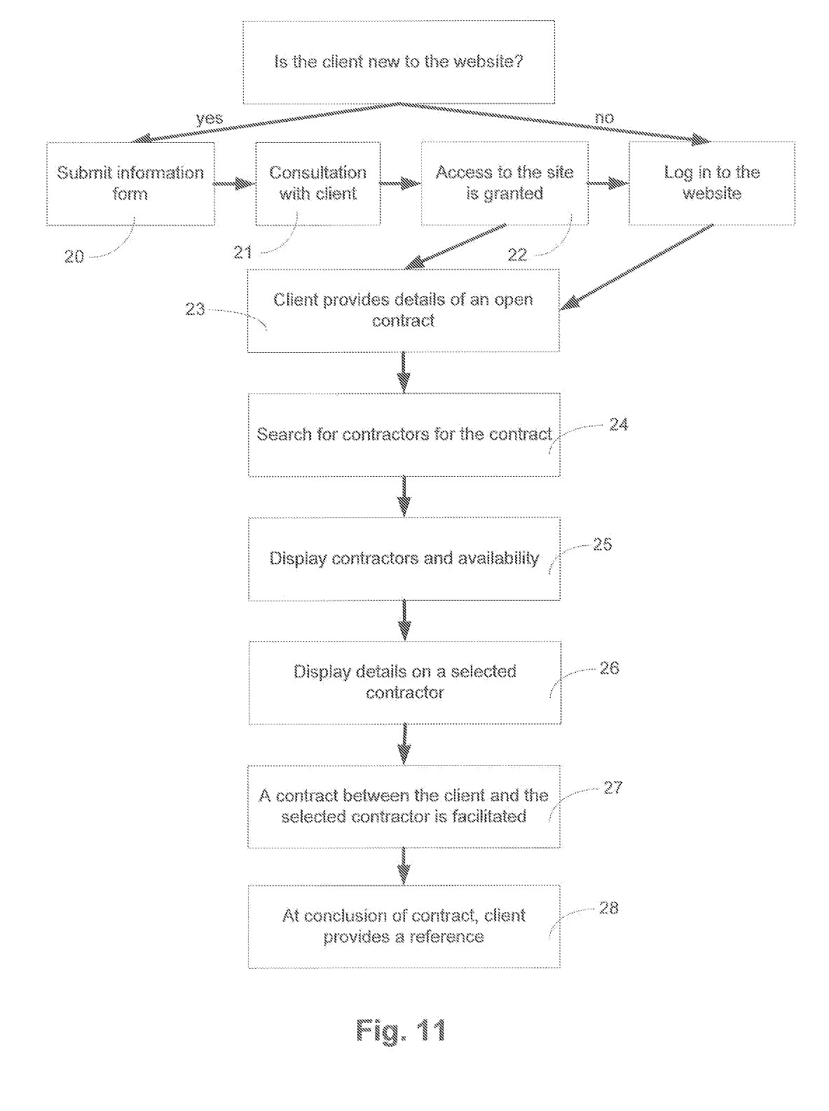

Referring to FIG. 11, how the system operates to assist employers locate contractors will be described.

For employers to access the system they will need to become clients of the recruitment consultancy.

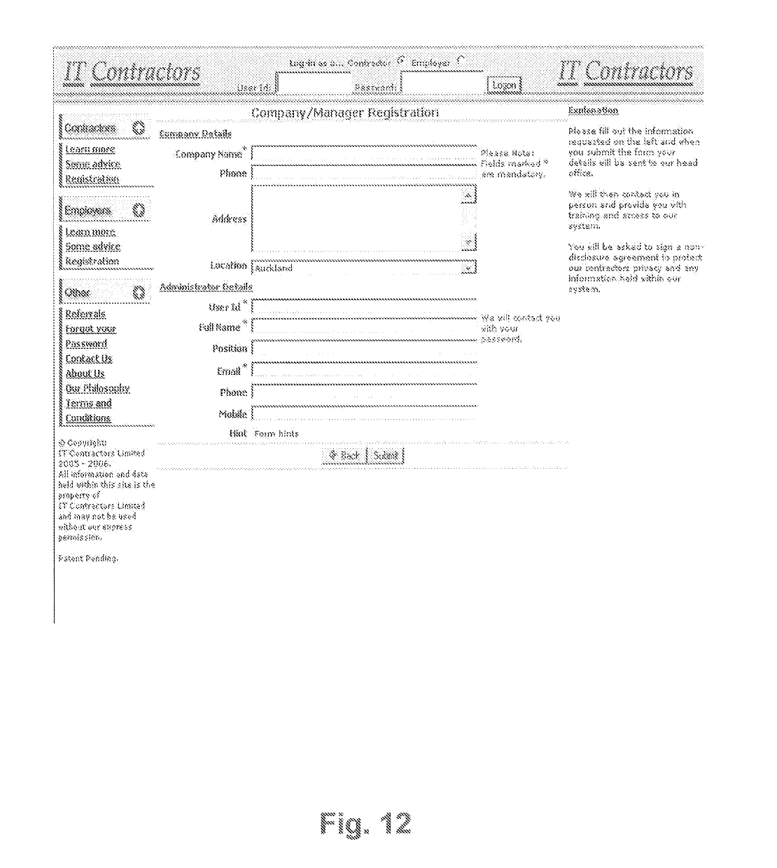

In step 10, an employer can submit an information form using the system to apply to access the system. An example of such a form is shown in FIG. 12.

In step 21 (FIG. 11), a consultation between the recruitment consultancy and the employer occurs in which the consultancy determines the requirements of the employer. If the employer is suitable for the system and wishes to obtain access, a contract between the consultancy and the employer is entered into and the employer becomes a client of the consultancy.

In step 22, access to the website is granted by allocating the client a username and password.

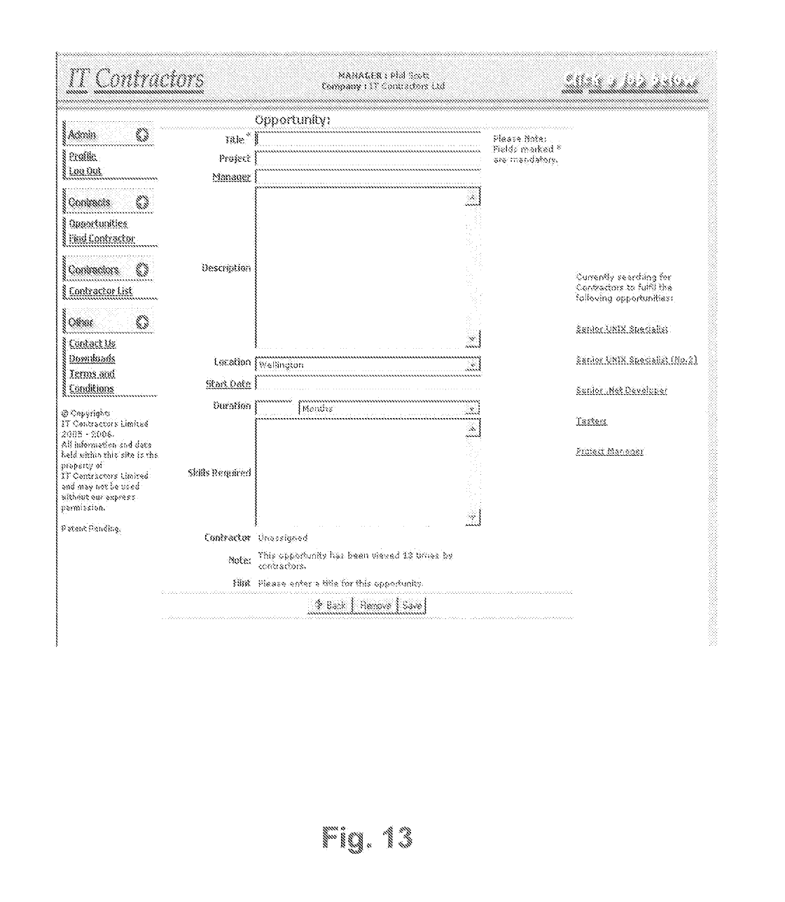

When the client accesses the website, they can provide details of open contracts in step 23, as shown in FIG. 13. The details can include project name, position, start date and duration.

In step 24, the client can search for contractors for their open contracts.

The client can search by skills required, level of competency required for the skill, and availability.

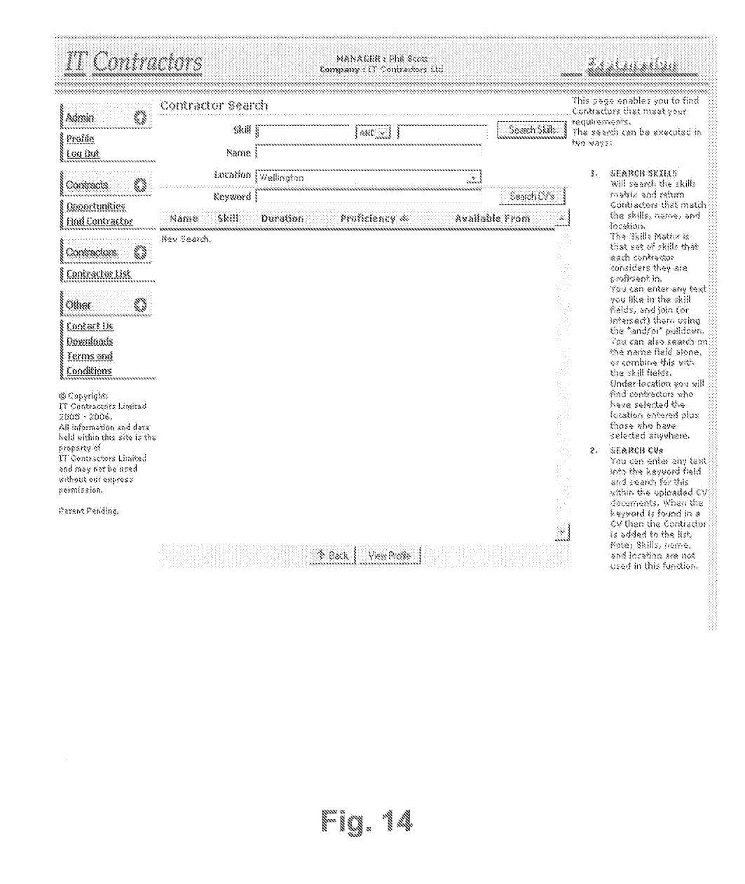

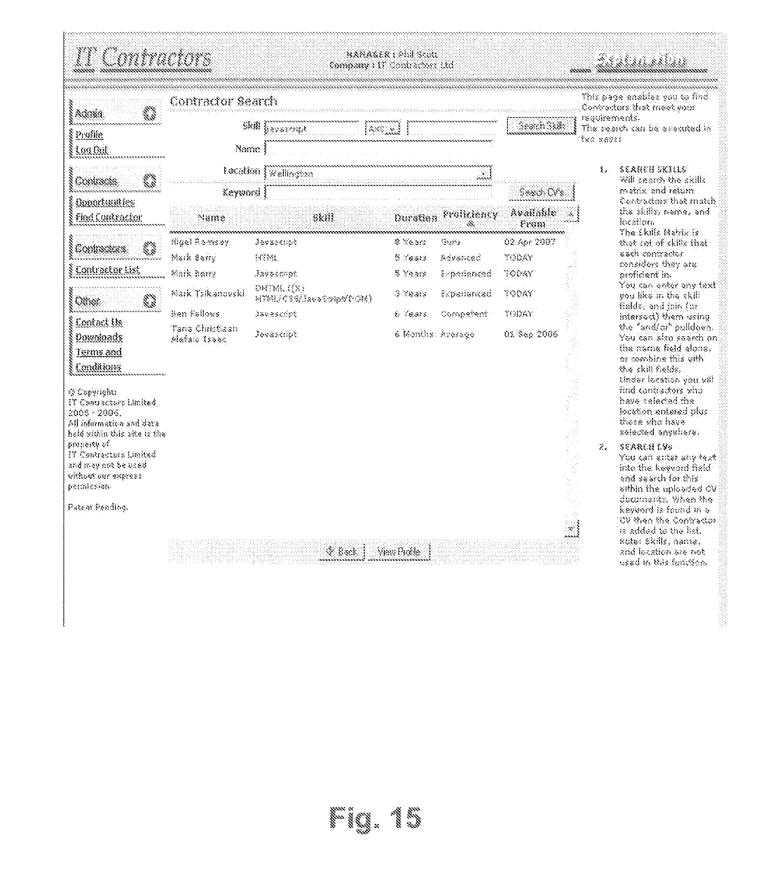

The search screen is shown in FIG. 14. The system displays the results of the search in step 25 and as shown, by example, in FIG. 15.

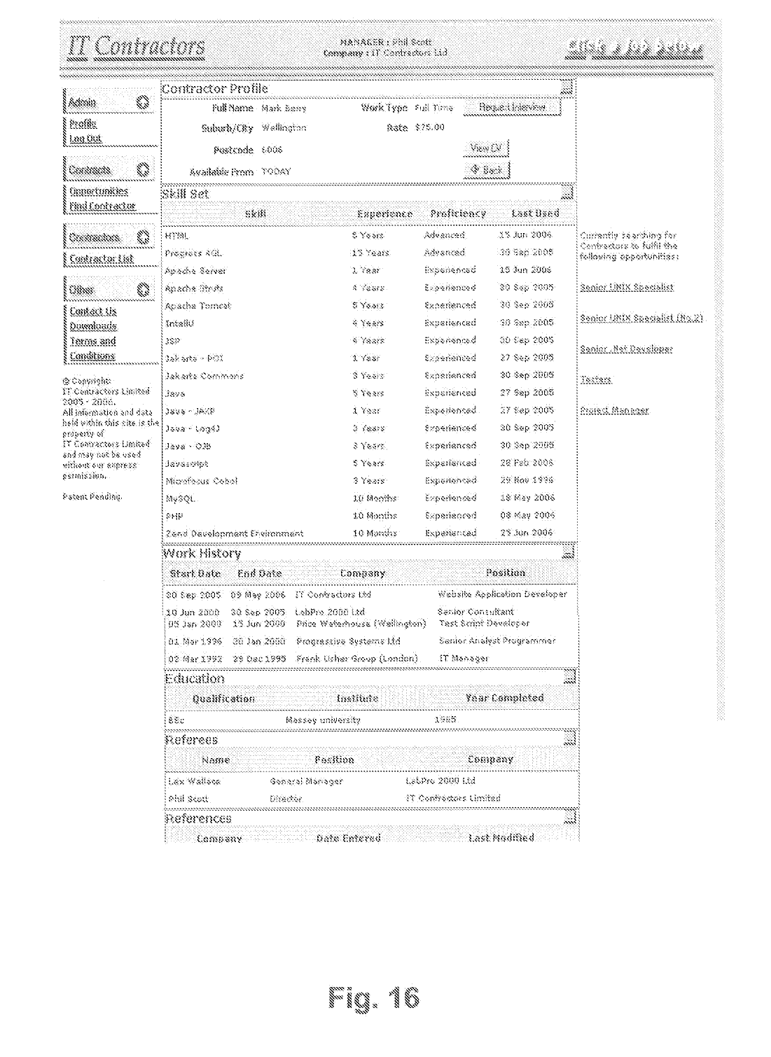

In step 26, the client can choose to view greater detail about a specific contractor. The screen shown in FIG. 16 displays an example of the detail available.

A running count of all views by clients of a contractor's details is collated and provided to the contractor when they use the system, to enable the contractor to determine likely prospects in the market place.

The greater detail can include information provided by the contractor, such as education details and skill details, references made available by the contractors, and information previously provided by the client of this contractor (including all references provided by the client for that contractor and notes made by the client about that contractor).

The client can also choose to view the full CV of a contractor.

In step 27, the system generates a contract between the client and the contractor based upon criteria initially determined by the client during the consultancy in step 21.

The contractor's availability within the system is set to unavailable between the start and end dates of the contract.

At the conclusion of the contract the client can provide a reference to the system for the contractor in step 28.

In addition, during the course of the contract the client can enter notes about the contractor within the system, and view notes previously made by the client for that contractor. The notes can include information such as notes about their contracting abilities so as to assist a client in the future when choosing the contractor.

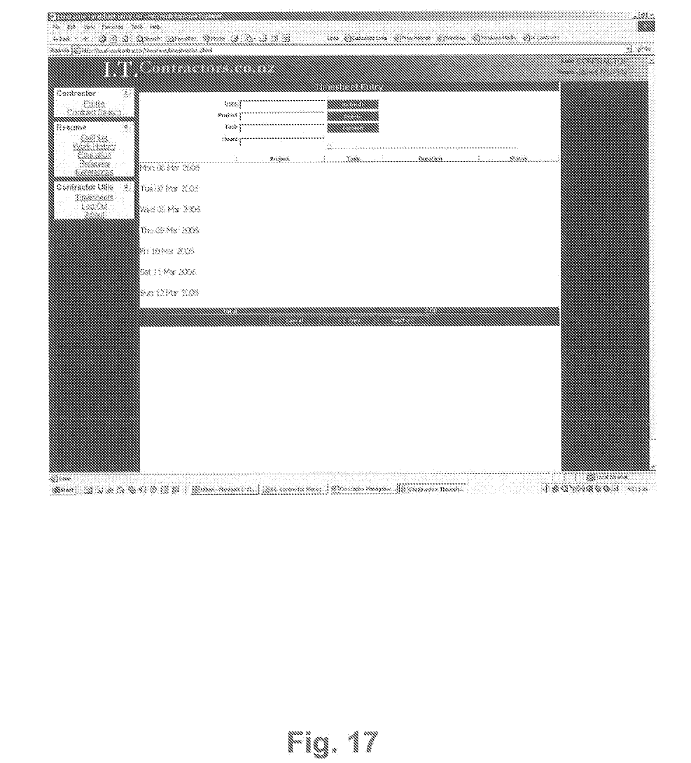

Timesheets can be entered on-line as the contractor works through a job as shown in FIG. 17. At the end of each week these may be forwarded to the client for approval. When the client approves the timesheet the system will automatically bill the client and when the money is received pay the contractor his agreed share.

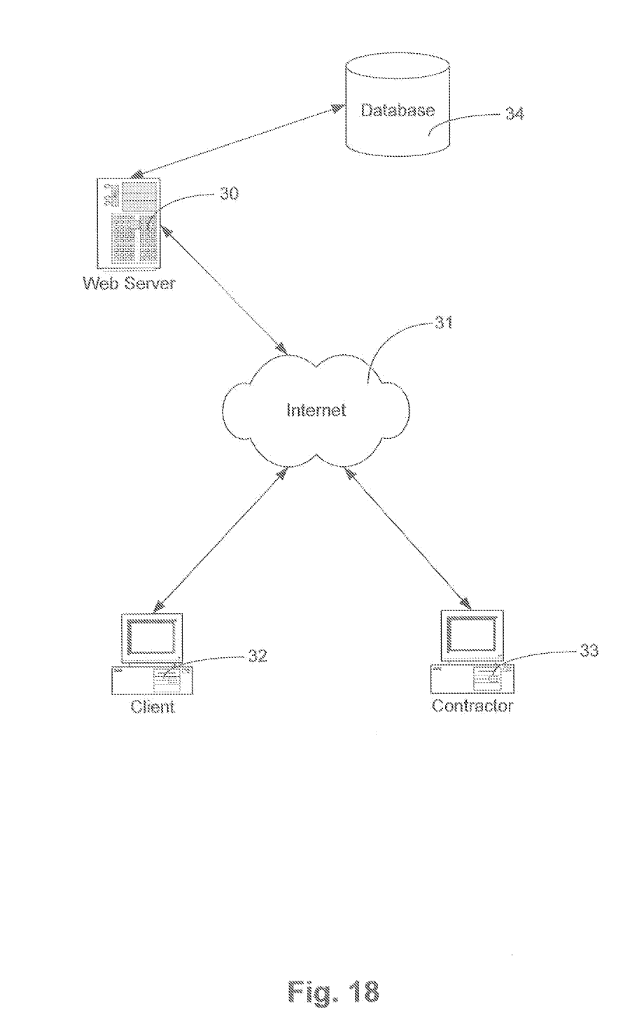

Referring to FIG. 18, an implementation of the system will be described.

The system is provided on a web server 30 providing access over the internet 31 to clients 32 and contractors 33.

Information provided by the contractors 33 is stored on a database 34 accessible by the web server 30.

Information provided by the client 32 is also stored on the database 34.

The web server 30 transmits the web pages depicted in FIGS. 2 to 11 to the contractor's computer 33. The contractor can views the web pages using an internet browser. The web server transmits the web pages depicted in FIGS. 12 to 17 to the client's computer 32. The client then views the web page using an internet browser.

The system may be implemented using MySQL, Apache and PHP.

It will be appreciated by those skilled in the art that the system may be implemented using any one of a number of software systems or in any programming language, including Java or Microsoft .NET.

The advantages of the system of the present invention include:
1. The efficiencies generated by the system mean that fee rates of the recruitment consultant for obtaining the contractor can be lower than current market rates.
2. The contractor can provide complete information about their Information Technology skills in the knowledge that the system will present their data to clients when an appropriate search is being carried out.
3. The contractor can provide a date when they will be available for contracts so that the clients can plan for future work more easily.
4. Clients can view the latest information about all participating contractors and have the best opportunity of selecting the most suitable candidates.
5. The running total of views of the contractor's details keeps them informed about likely prospects in the market place.
6. The client can retain private information about contractors that work for them and thus make it easier to choose the most suitable one in the future.
7. The system facilitates the provision of a reference by the client for a contractor at the expiry of their contract as well as enabling the contractor to provide the reference, if desired, to potential employers.
8. Online timesheets makes it much easier to ensure that hours worked are kept correctly and helps ensure accurate charging of fees.
9. By providing all contractors, whether available or not, and availability of all contractors, the client is able to search for contractors and enter into a contract with a contractor when the contractor is working on another contract.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A computer-implemented method for recruiting a contractor for a position in one of a plurality of organisations, including the steps of:
(i) determining the availability of a contractor using a database of contractors; and
(ii) reserving the contractor for the position;
wherein at least some of the contractors in the database are contracted for a period of time to an organisation and the database includes information related to the end date for each period of time.

2. A method as claimed in claim 1 wherein the organisation recruiting the contractor directly determines the availability in step (i).

3. A method as claimed in claim 2 wherein the organisation determines the availability using a graphical user interface.

4. A method as claimed in claim 3 wherein the graphical user interface is executing on a browser.

5. A method as claimed in claim 4 wherein the database is stored on a server and the browser is connected to the server over a network.

6. A method as claimed in claim 5 wherein the network is the internet.

7. A method as claimed in claim 1 wherein the organisation recruiting the contractor directly reserves the contractor in step (ii).

8. A method as claimed in claim 7 wherein the organisation reserves the contractor using a graphical user interface.

9. A method as claimed in claim 8 wherein the graphical user interface is executing on a browser.

10. A method as claimed in claim 9 wherein the database is stored on a server and the browser is connected to the server over a network.

11. A method as claimed in claim 10 wherein the network is the internet.

12. A method as claimed in claim 1 wherein the database includes a list of skills for each contractor.

13. A method as claimed in claim 12 wherein the database includes a rating for each of the skills.

14. A method as claimed in claim 13 wherein the rating is based on the performance of the contractor under previous contracts.

15. A method as claimed in claim 1 wherein the database includes a self rating for each contractor.

16. A method as claimed in claim 15 wherein at least some of the self ratings have been validated by an independent party.

17. A method as claimed in claim 1 wherein the database includes references for each contractor.

18. A method as claimed in claim 1 wherein the database includes one or more notes for one or more contractors by one or more organisations.

19. A method as claimed in claim 1 wherein the contractor is an Information Technology contractor.

20. A method as claimed in claim 1, wherein the step of determining the availability of a contractor is based at least in part on the end date for each period of time.

21. A method as claimed in claim 1, which includes the step of displaying a list of available contractors.

22. A method as claimed in claim 21, wherein the list of available contractors comprises the end date for each contractor contained therein.

23. A method as claimed in claim 21, wherein the displaying comprises directly displaying the list to the organisation recruiting the contractor.

24. A system for recruiting a contractor for a position in one of a plurality of organisations, including:
(i) a memory arranged for storing a database, the database arranged for storing information about contractors; and
(ii) a processor arranged for determining the availability of a contractor using the database and reserving the contractor for the position;
wherein at least some of the contractors in the database are contracted for a period of time to an organisation and the database includes information related to the end date for each period of time.

25. A system as claimed in claim 24, wherein the memory and the processor are arranged to enable the organisation recruiting the contractor to directly determine the availability.

26. A system as claimed in claim 24, wherein the processor is arranged to determine the availability based at least in part on the end date for each period of time.

27. A system as claimed in claim 24, which includes a display for displaying a list of available contractors.

28. A system as claimed in claim 27, wherein the list of available contractors comprises the end date for each contractor contained therein.

29. A system as claimed in claim 27, wherein the display is arranged to directly display the list to the organisation recruiting the contractor.

30. A system for implementing the method of claim 1.

31. Software for implementing the method of claim 1.

32. Storage media arranged for storing the software as claimed in claim 31.

33. (canceled)
